(19) United States
(12) Patent Application Publication
(10) Pub. No.: US 2015/0003669 A1
(43) Pub. Date: Jan. 1, 2015

(54) 3D OBJECT SHAPE AND POSE ESTIMATION AND TRACKING METHOD AND APPARATUS

(71) Applicant: TOYOTA MOTOR ENGINEERING & MANUFACTURING NORTH AMERICA, INC., Erlanger, KY (US)

(72) Inventors: Mojtaba Solgi, East Lansing, MI (US); Michael R. James, Northville, MI (US); Danil Prokhorov, Canton, MI (US); Michael Samples, Ann Arbor, MI (US)

(21) Appl. No.: 13/930,317

(22) Filed: Jun. 28, 2013

(51) Int. Cl. G06K 9/00; G06T 7/00

(52) U.S. Cl. CPC G06K 9/00201; G06T 7/0051
USPC 382/103

(57) ABSTRACT

A method and apparatus for estimating and tracking a 3D object shape and pose estimation is disclosed A plurality of 3D object models of related objects varying in size and shape are obtained, aligned and scaled, and voxelized to create a 2D height map of the 3D models to train a principle component analysis model. At least one sensor mounted on a host vehicle obtains a 3D object image. Using the trained principle component analysis model, the processor executes program instructions to estimate the shape and pose of the detected 3D object until the shape and pose of the detected 3D object matches one principle component analysis model. The output of the shape and pose of the detected 3D object is used in one vehicle control function.

### BACKGROUND

The present invention relates, to 3D object identification and tracking methods and apparatus.

Real time mapping of 2D and 3D images from image detectors, such as cameras, is used for object identification.

In manufacturing, known 2D shapes or edges of objects are compared with actual object shapes to determine product quality.

However, 3D object recognition is also required in certain situations. 3D object segmentation and tracking methods have been proposed for autonomous vehicle applications. However, such methods have been limited to objects with a fixed 3D shape. Other methods attempt to handle variations in 2D shapes, i.e., (the contour of an object in 2D). However, these methods lack the ability to model shape variations in 3D space.

Modeling such 3D shape variations may be necessary in autonomous vehicle applications. The rough estimate of the state of some object i.e., other cars on the road, may be sufficient in some cases requiring simple object detection, such as blind spot and back up object detection applications. More detailed information on the state of the objects seems to be necessary as 3D objects, i.e., vehicles, change shape, size and pose when the vehicle turns in front of another vehicle, for example, or the location of a parked vehicle in the parking vehicle changes relative to a moving host vehicle.

### SUMMARY

A method for estimating the shape and pose of a 3D object includes detecting a 3D object external to a host vehicle using at least one image sensor, using a processor, to estimate at least one of the shape and pose of the detected three 3D object as at least one of the host vehicle and the 3D object change position relative to each other, and providing an output of the 3D object shape and pose.

The method further obtaining a plurality of 3D object models, where the models are related to a type of object, but differ in shape and size, using a processor, to align and scale the 3D object models, voxelizing the aligned and scaled 3D object models, creating a 2D height map of the voxelized 3D object models, and training a principle component analysis model for each of the shapes of the plurality of 3D object models.

The method stores the 3D object models in a memory.

For each successive image of the 3D object, the method iterates the estimation of the shape and pose of the object until the model of the 3D object matches the shape and pose of the detected 3D object.

An apparatus for estimating the shape and pose of a 3D object relative to a host vehicle includes at least one sensor mounted in a vehicle for sensing a 3D object in a vehicle's vicinity and a processor, coupled to the at least one sensor. The processor is operable to: obtain a 3D object image from the at least one sensor, estimating the shape of the object in the 3D object image, estimating the pose of the 3D object in the 3D object image, optimizing the estimated shape and pose of the 3D object until the estimated 3D object shape and pose substantially matches the 3D object image; and outputting the shape and pose of the optimized 3D object.

The apparatus includes a control mounted on the vehicle for controlling at least one vehicle function, with the processor transmitting the output of the optimized shape and pose of the 3D object to the vehicle control for further processing.

### BRIEF DESCRIPTION OF THE DRAWING

Various features, advantages and other uses of the present invention will become more apparent by referring to the following detailed description and drawing in which:

FIG. 1 is a pictorial representation of a vehicle implementing the 3D object shape and pose estimation and tracking method and apparatus;

FIG. 2 is a block diagram showing the operational inputs and outputs of the method and apparatus;

FIG. 3 is a block diagram showing the sequence for training the PCA latent space model of 3D shapes;

FIG. 4 is a pictorial representation of stored object models;

FIG. 5 is a pictorial representation of the implementation of the method and apparatus showing the original 3D model of an object, the 3D model aligned and scaled, the aligned model voxelized, and the 2D height map of the model used for training PCA model;

FIG. 6 is a demonstration of the learned PCA latent space for the 3D shape of the vehicle;

FIG. 7 is a block diagram of the optimization sequence used in the method and apparatus;

FIG. 8 is a sequential pictorial representation of the application of PWP3D on segmentation and pose estimation of a vehicle showing, from top to bottom, and left to right, the initial pose estimated by a detector, and sequential illustrations of a gradient-descent search to find the optimal pose of the detected vehicle; and

FIG. 9 is a sequential series of image segmentation results of the present method and apparatus on a detected video of a turning vehicle.

### DETAILED DESCRIPTION

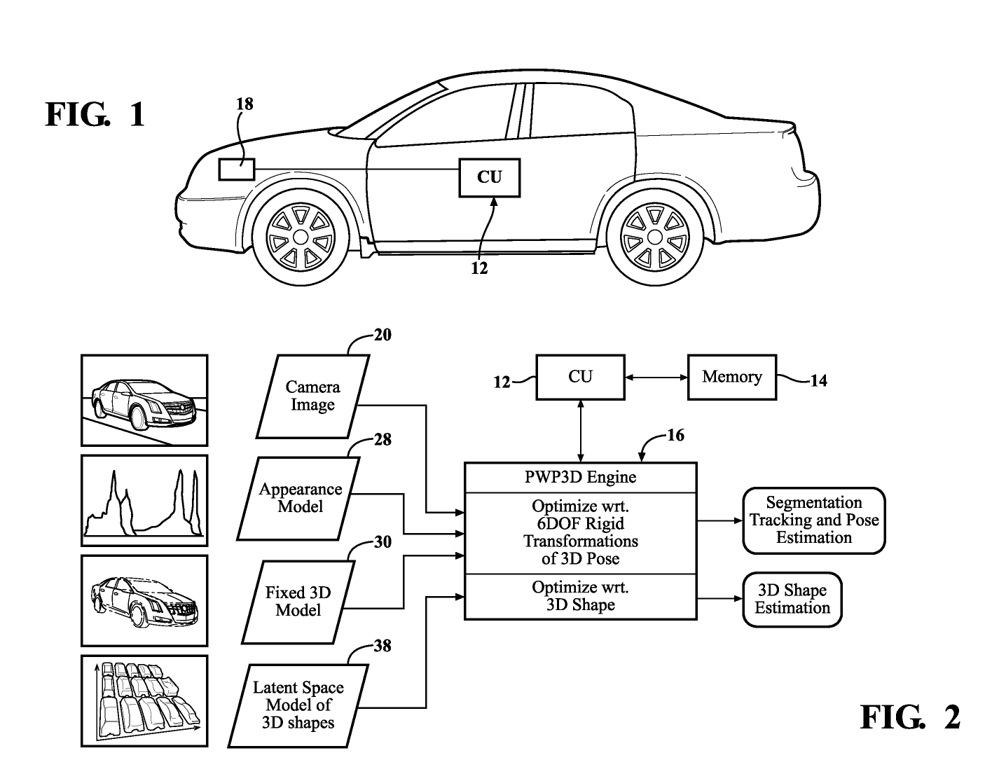

Referring now to FIGS. 1-7 of the drawing, there is depicted a method and apparatus for 3D object shape and pose estimation and object tracking.

By way of example, the method and apparatus is depicted as being executed on a host vehicle 10. The host vehicle 10 may be any type of moving or stationary vehicle, such as an automobile, truck, bus, golf cart, airplane, train, etc.

A computing unit or control 12 is mounted in the vehicle, hereafter referred to as a “host vehicle,” for executing the method. The computing unit 12 may be any type of computing unit using a processor or a central processor in combination with all of the components typically used with a computer, such as a memory, either RAM or ROM for storing data and instructions, a display, a touch screen or other user input device or interface, such as a mouse, keyboard, microphone, etc., as well as various input and output interfaces. In the vehicle application described hereafter, the computing unit 12 may be a stand-alone or discrete computing unit mounted in the host vehicle 10. Alternately, the computing unit 12 may be any of one or more of the computing units employed in a vehicle, with the PWP3D engine 16 control program, described hereafter, stored in a memory 14 associated with the computing unit 12.

The PWP3D engine 16 may be used in combination with other applications found on the host vehicle 10, such as lane detection, blind spot detection, backup object range detector autonomous vehicle driving and parking, collision avoidance, etc.

A control program implementing the PWP 3D engine 16 can be stored in the memory 14 and can include a software program or a set of instructions in any programming language, source code, object code, machine language, etc., which is executed by the computing unit 12.

Although not shown, the computing unit 12 may interface with other computing units in the host vehicle 10, which control vehicle speed, navigation, breaking and signaling applications.

In conjunction with the present methods the apparatus includes inputs from sensors 18 mounted on the host vehicle 10 to provide input data to the computing unit 12 for executing the PWP3D engine 16. Such sensors 18, in the present example, may include one or more cameras 20, shown in FIG. 2, mounted at one or more locations on the host vehicle 10. In a single camera 20 application, the camera 20 is provided with a suitable application range including a focal point and a field of view. In a multiple camera application, each camera may be mounted a relatively identical location or different locations and may be provided with the same or different application range, including field of view and focal point.

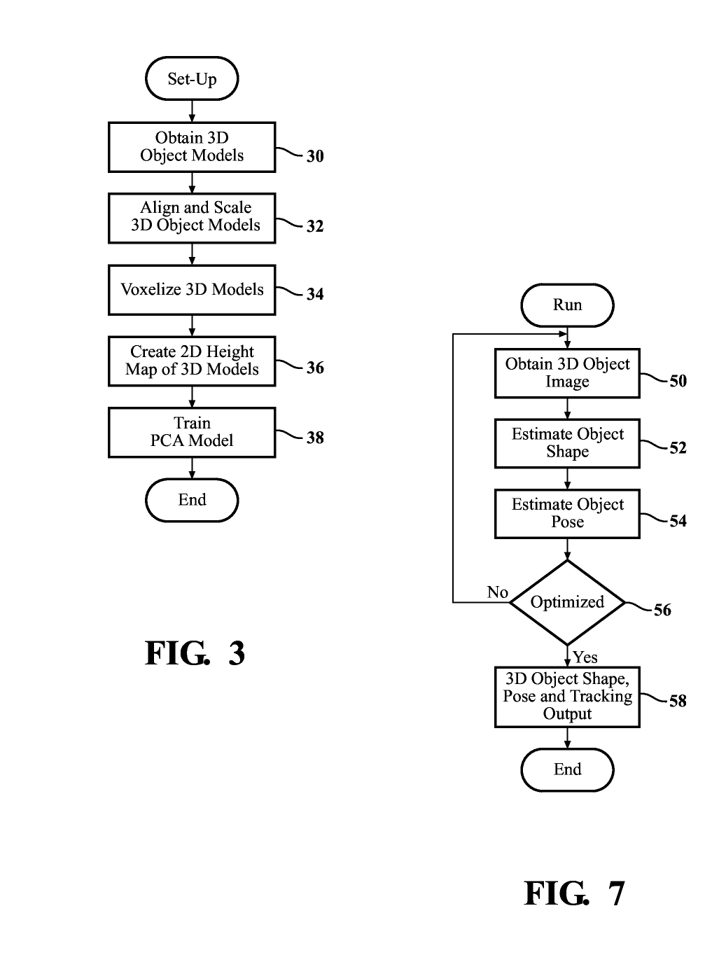

According to the method and apparatus, the first step 30 in the set up sequence, as shown in FIG. 3 is implemented to perform optimization in the 3D space shape. First, the method trains a Principle Component Analysis (PCA) latent space model of 3D shapes.

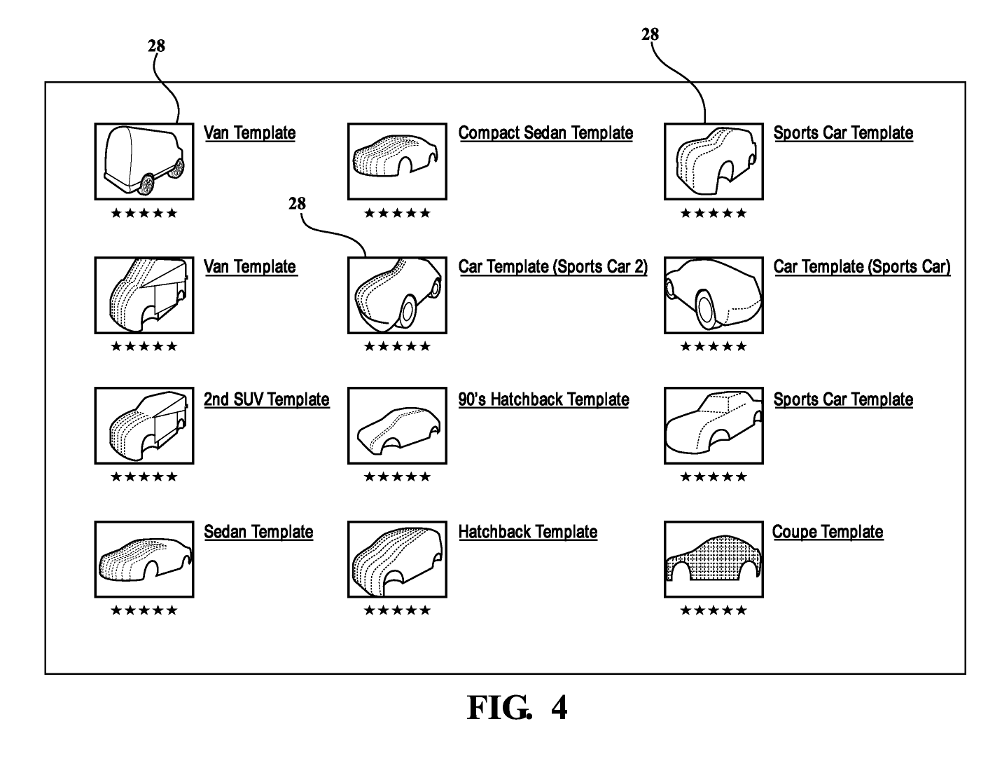

This optimization includes step 30, (FIG. 3), in which a set of 3D object models are obtained. As shown in FIG. 4, such models can be obtained from a source such as the Internet, data files etc., to show a plurality of different, but related, objects such as a plurality of 3D vehicles, such as vans, SUVs, sedans, hatchbacks, coupes and sport cars. The object images are related in type, but differ in size and/or shape.

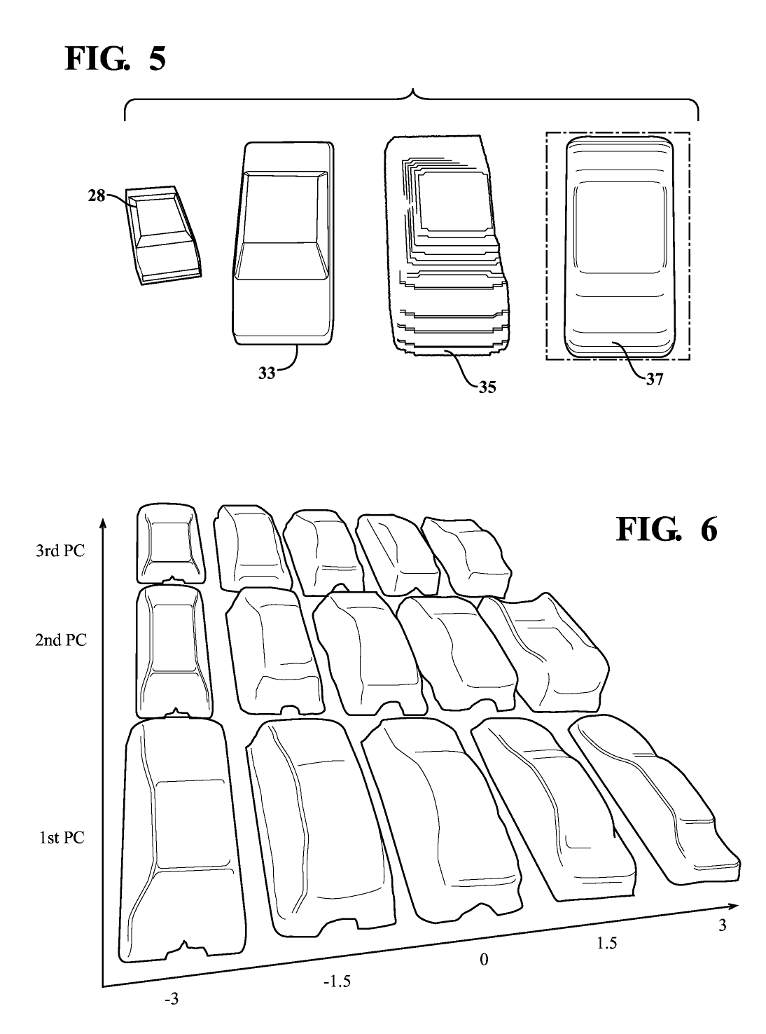

Next, trimesh is applied in step 32 to the 3D models obtained in step 30, to align and scale the 3D models, see the second model 33 in FIG. 5.

Next, in step 34, the 3D model data from step 32 is voxelized as shown in the model at horizontal axis 3 in FIG. 5.

Next, in step 36, a 2D height map of the 3D voxelized models from step 34 is created for each model 28 obtained in step 30 resulting in model 37 in FIG. 5.

Finally, in step 38, the PCA and latent variable model is trained using the 2D height maps from step 36.

In FIG. 6, the learned PCA latent space is demonstrated for 3D shapes of vehicles. The vertical axis shows the first three principle components representing the major directions of variation in data. The horizontal axis shows the variations of the mean shape (index 0) along each principle component (PC). The indices along the horizontal axis are the amount of deviation from the mean in units of square root of the corresponding Eigen value. It should be noted in FIG. 6, that the first PC intuitively captures the important variations of vehicle fix. For example, the first PC captures the height of the vehicle (minus 3 in the horizontal axis represents an SUV and 3 represents a short sporty vehicle).

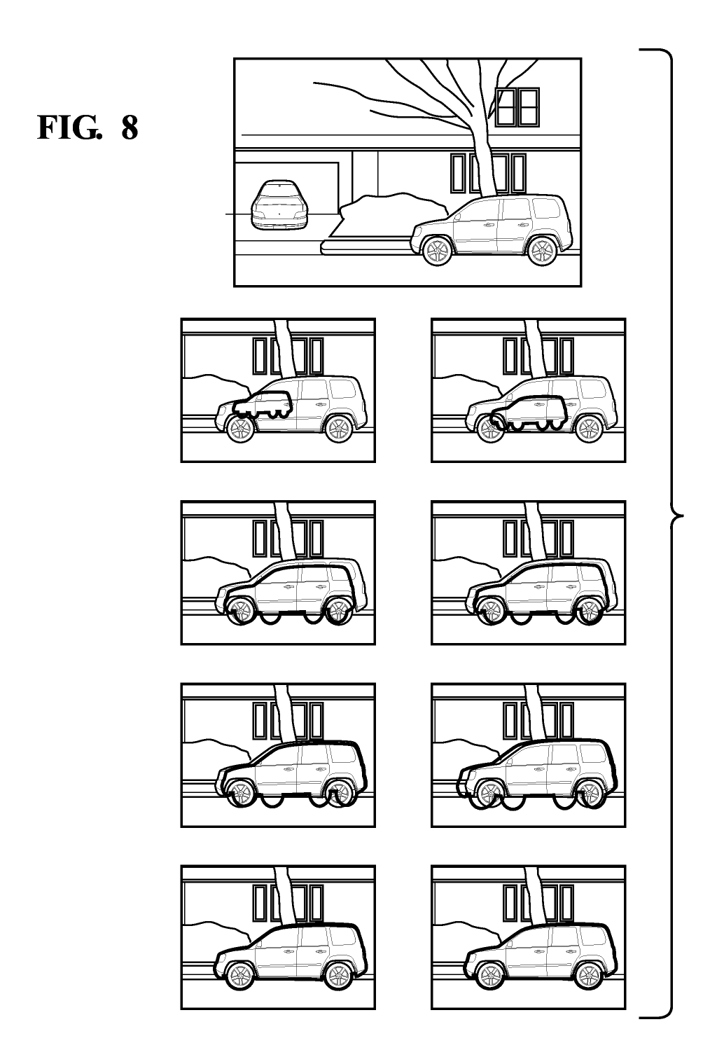

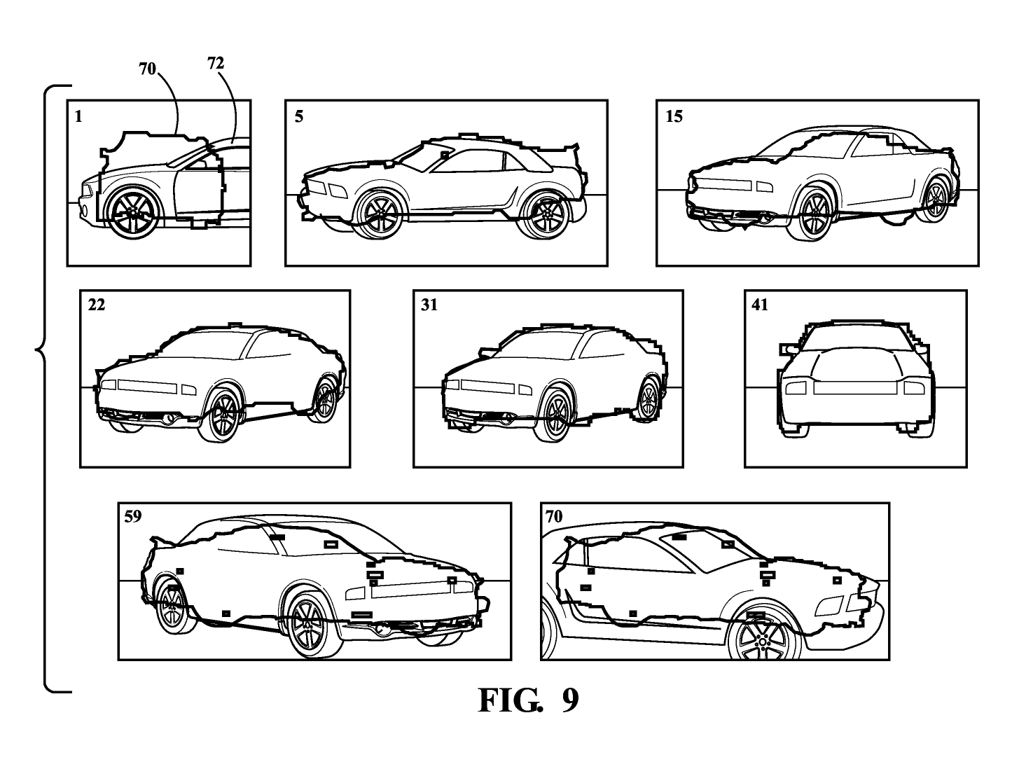

In obtaining real time 3D object identification, the computing unit 12, in step 50, FIG. 2, executing the stored set of instructions or program, first obtains a 3D object image from a sensor 28, such as a camera 20. FIG. 8 shows an example of an initial 3D object image 60. Next, the computing unit 12 estimates the shape of the object in step 52 and then estimates the pose of the object in step 54. These steps executed on the object image 60 in FIG. 8 are shown by the subsequent figures in FIG. 8 in which an estimate of the object shape is superimposed over the object image. It will be understood that in real time, only the estimated object shape and pose is generated 60 by the method and apparatus, as the method is optimizing or comparing the estimated 3D object shape and pose with the initial image object 60. Various iterations of step 56 are undertaken until the 3D object shape and pose is optimized. At this time, the 3D object shape and pose can be output in step 58 by the computing unit 12 for other uses or to other computing units or applications in the host vehicle 10, such as collision avoidance, vehicle navigation control, acceleration and/or braking, geographical information, etc. for the control of a vehicle function.

In order to implement the optimization of the latent space model, the following equations are derived

$$E ( Φ ) = - {\sum }_{x ∈ Ω} log ( {H}_{e} ( Φ ) {P}_{f} + ( 1 - {H}_{e} ( Φ ) ) Pb ) \qquad ( 1 )$$

Where He is the Heaviside step function, is the sign distance function of the contour of the projection of the 3D model, P_{f} and P_{b} are the posterior probabilities of the pixel x belonging to foreground and background, respectively. The objective is to compute the partial derivatives of the energy function with respect to the PCA latent space variables, [symbol] .

$$\begin{matrix}\frac{\partial E}{\partial {γ}_{i}} = - {\sum }_{x ∈ Ω} \frac{{P}_{f} - {P}_{b}}{{H}_{e} ( Φ ) {P}_{f} + ( 1 - {H}_{e} ( Φ ) ) {P}_{b}} \frac{\partial {H}_{e} ( Φ ( x , y ) )}{\partial {γ}_{i}} & ( 2 ) \\ \frac{\partial {H}_{e} ( Φ ( x , y ) )}{\partial {γ}_{i}} = \frac{\partial {H}_{e} ( Φ )}{\partial Φ} \cdot ( \frac{\partial Φ}{\partial x} \frac{\partial x}{\partial {γ}_{i}} + \frac{\partial Φ}{\partial y} \frac{\partial y}{\partial {γ}_{i}} ) & ( 3 )\end{matrix}$$

$$\frac{\partial {H}_{e} ( Φ )}{\partial Φ} ,$$

the derivative of the Heaviside step function, is the Dirac delta function δ(Φ), whose approximation is known. Also

$$\frac{\partial Φ}{\partial x}$$

$$and$$

$$\frac{\partial Φ}{\partial y}$$

are trivally computed, given the signed distance function, Φ(x,y). The only unknowns so far are

$$\frac{\partial Φ}{\partial {γ}_{i}}$$

$$and$$

$$\frac{\partial Φ}{\partial {γ}_{i}} .$$

In the following derivations, the unknowns can be reduced to computing the derivatives of [symbol] given the camera model.

$$[ \begin{matrix}x \\ y\end{matrix} ] = [ \begin{matrix}{f}_{u} \frac{{X}_{c}}{{Z}_{c}} + {u}_{o} \\ {f}_{v} \frac{{X}_{c}}{{Z}_{c}} + {v}_{o}\end{matrix} ] \qquad ( 4 )$$

Where fᵤ and fᵥ are horizontal and vertical focal lengths of the camera and [symbol] is the center pixel of the image (all available from the intrisic camera calibration parameters), X_{c}= [symbol] is the 3D point in the camera coordinates that productes to pixel (x,y). The mapping from image to camera and image to object coordinate systems are known and can be stored during the rendering of the 3D model. This results in the following equations with reduction of the unknowns to

$$\frac{\partial {X}_{c}}{\partial {γ}_{i}} ,$$

$$\begin{matrix}\frac{\partial x}{\partial {γ}_{i}} = {f}_{u} \frac{1}{Z} \frac{\partial {X}_{c}}{\partial {γ}_{i}} - {f}_{u} \frac{{X}_{c}}{{Z}_{c}^{2}} \frac{\partial {Z}_{c}}{\partial {γ}_{i}} & ( 5 ) \\ \frac{\partial y}{\partial {γ}_{i}} = {f}_{u} \frac{1}{{Z}_{c}} \frac{\partial {Y}_{c}}{\partial {γ}_{i}} - {f}_{u} \frac{{X}_{c}}{{Z}_{c}^{2}} \frac{\partial {Z}_{c}}{\partial {γ}_{i}} & ( 6 )\end{matrix}$$

Accordingly, the results is the following mapping from object coordinates to camera coordinates:

X_{c}=RD+T (7)

Where R and T are object rotation and translation matrices and X is the corresponding 3D point in object coordinates. Consequently,

$$\begin{matrix}\frac{\partial {X}_{c}}{\partial {γ}_{i}} = {r}_{00} \frac{\partial X}{\partial {γ}_{i}} + {r}_{01} \frac{\partial Y}{\partial {γ}_{i}} + {r}_{02} \frac{\partial Z}{\partial {γ}_{i}} & ( 8 ) \\ \frac{\partial {Y}_{c}}{\partial {γ}_{i}} = {r}_{10} \frac{\partial X}{\partial {γ}_{i}} + {r}_{11} \frac{\partial Y}{\partial {γ}_{i}} + {r}_{12} \frac{\partial Z}{\partial {γ}_{i}} & ( 9 ) \\ \frac{\partial {Z}_{c}}{\partial {γ}_{i}} = {r}_{20} \frac{\partial X}{\partial {γ}_{i}} + {r}_{21} \frac{\partial Y}{\partial {γ}_{i}} + {r}_{22} \frac{\partial Z}{\partial {γ}_{i}} & ( 10 )\end{matrix}$$

Where rᵢⱼ is the elements of matrix at a location R at location i and j. To make the derivationats shorter and the notations more clear, an assumption is that the stixel mesh model and the object coordinates are the same, where the height of each cell in the stixel Z and its 2D coordinates is (X,X,). This assumption does not hurt the generality of the derivations, as mapping from stixel to object coordinate (rotation and translation) easily translates to an extra step in this inference. Since only the height of the stixels change as a function of the latent variables [symbol] , the results is:

$$\frac{\partial X}{\partial {γ}_{i}} = 0 \\ \frac{\partial Y}{\partial {γ}_{i}} = 0 \qquad ( 11 )$$

And the only remaining unknown is

$$\frac{\partial Z}{\partial {γ}_{i}} .$$

Each 3D point in object coordinates, X=(X, Y,Z),falls on a triangular face in the stixel triangular mesh model, say with vertices of coordinates Xⱼ=(Xⱼ, Yj,Zj) for j=1,2,3. Moreover, change in Z is only dependent on Z₁, Z₂ and Z₃ (and not other vertex in the 3D mesh. Therefore, the chain rule gives:

$$\frac{\partial Z}{\partial {γ}_{i}} = {\sum }_{j = 1}^{3} \frac{\partial Z}{\partial {Z}_{j}} \frac{\partial {Z}_{j}}{\partial {γ}_{i}} \qquad ( 12 )$$

Since the method uses a PCA latent space, every stixel model Z can be represented as a linear combination of principle components as follows.

$$Z = \overline{Z} + {\sum }_{i = 1}^{D} {γ}_{i} {Γ}_{i} \qquad ( 13 )$$

Where Z is the mean stixel, D is the number of dimensions in the latent space, and [symbol] is the i^{th} eigen vector. Eq. 13 implies:

$$\frac{\partial {Z}_{j}}{\partial {γ}_{i}} = {Γ}_{i , j} j = 1 , 2 , 3 \qquad ( 14 )$$

Where r_{i,j} is the j^{th} element of the eigen vector. Since each face in the mesh model is a plane in 3D space which passes through X, X₁, X₂, and X₃, if the plane is represented with parameters A, B, C, D, the result is:

$$AX + BY + CZ + D = 0 ⇒ Z = \frac{- 1}{C} ( D + AX + BY ) \qquad ( 15 )$$

and hence:

$$\frac{\partial Z}{\partial {Z}_{i}} = \frac{- 1}{C} ( X \frac{\partial A}{\partial {Z}_{i}} + Y \frac{\partial B}{\partial {Z}_{i}} ) , i = 1 , 2 , 3 \qquad ( 16 )$$

Substituting X₁, X₂ and X₃ and then solving the system of equations gives A,B,C, and D by the following determinants:

$$A = \vert \begin{matrix}1 & {Y}_{1} & {Z}_{1} \\ 1 & {Y}_{2} & {Z}_{2} \\ 1 & {Y}_{3} & {Z}_{3}\end{matrix} \vert , B = \vert \begin{matrix}{X}_{1} & 1 & {Z}_{1} \\ {X}_{2} & 1 & {Z}_{2} \\ {X}_{3} & 1 & {Z}_{3}\end{matrix} \vert \\ C = \vert \begin{matrix}{X}_{1} & {Y}_{1} & 1 \\ {X}_{2} & {Y}_{2} & 1 \\ {X}_{3} & {Y}_{3} & 1\end{matrix} \vert , D = \vert \begin{matrix}{X}_{1} & {Y}_{1} & {Z}_{1} \\ {X}_{2} & {Y}_{2} & {Z}_{2} \\ {X}_{3} & {Y}_{3} & {Z}_{3}\end{matrix} \vert \qquad ( 17 )$$

Expanding the determinants and solving for partial derivatives of Eq. 16 yields:

$$\frac{\partial A}{\partial {Z}_{i}} = {Y}_{3} - {Y}_{2} , \frac{\partial B}{\partial {Z}_{i}} = {X}_{2} - {X}_{3} , \\ \frac{\partial C}{\partial {Z}_{i}} = 0 , \frac{\partial D}{\partial {Z}_{i}} = - {X}_{2} {Y}_{3} + {X}_{3} {Y}_{2} \qquad ( 18 )$$

Finally, substituting Eq. 18 into Eq. 16, the result is:

$$\frac{\partial Z}{\partial {Z}_{1}} = \frac{X ( {Y}_{2} - {Y}_{3} ) + {X}_{2} ( {Y}_{3} - Y ) + {X}_{3} ( Y - {Y}_{2} )}{{X}_{1} ( {Y}_{2} - {Y}_{3} ) + {X}_{2} ( {Y}_{3} - {Y}_{1} ) + {X}_{3} ( {Y}_{1} - {Y}_{2} )} \qquad ( 19 )$$

$$\frac{\partial Z}{\partial {Z}_{2}} and \frac{\partial Z}{\partial {Z}_{3}}$$

are similarly derived. Therefore, the derivatives of the energy function with respect to latent variables is derived now. A bottom-up approach to computing

$$\frac{\partial E}{\partial {γ}_{i}} ,$$

which is used in the algorithms is substituting data into the equations in the following order:

Algorithm 1: Algorithm for optimizing the shape of the object
with respect to the latent variables of shape space.

| | |
|---|---|
| 1: | for each latent variable γᵢ do |
| 2: | Ei ← 0 |
| 3: | for each pixel (x, y) ∈ Ω do |
| 4: | Find the corresponding X, X₁, X₂ and X₂ in object/stixel coordinates |
| | (known fromrendering and projection matrices). |
| 5: | $\frac{\partial Z}{\partial {Z}_{1}} ← \frac{X ( {Y}_{2} - {Y}_{3} ) + {X}_{2} ( {Y}_{3} - Y ) + {X}_{3} ( Y - {Y}_{2} )}{{X}_{1} ( {Y}_{2} - {Y}_{3} ) + {X}_{2} ( {Y}_{3} - {Y}_{1} ) + {X}_{3} ( {Y}_{1} - {Y}_{2} )} and similarly \frac{\partial Z}{\partial {Z}_{2}} and \frac{\partial Z}{\partial {Z}_{3}}$ |
| 6: | $\frac{\partial {Z}_{j}}{\partial {γ}_{i}} ← {Γ}_{i , j} for j = 1 , 2 , 3$ |
| 7: | $\frac{\partial Z}{\partial {γ}_{i}} ← {\sum }_{j = 1}^{3} \frac{\partial Z}{\partial {Z}_{j}} \frac{\partial {Z}_{j}}{\partial {γ}_{i}}$ |
| 8: | $\frac{\partial {X}_{c}}{\partial {γ}_{i}} ← {r}_{02} \frac{\partial Z}{\partial {γ}_{i}} and \frac{\partial {Y}_{c}}{\partial {γ}_{i}} ← {r}_{12} \frac{\partial Z}{\partial {γ}_{i}} and \frac{\partial {Z}_{c}}{\partial {γ}_{i}} ← {r}_{22} \frac{\partial Z}{\partial {γ}_{i}}$ |
| 9: | $\frac{\partial y}{\partial {γ}_{i}} ← {f}_{v} \frac{1}{{Z}_{c}} \frac{\partial {Y}_{c}}{\partial {γ}_{i}} - {f}_{u} \frac{{X}_{c}}{{Z}_{c}^{2}} \frac{\partial {Z}_{c}}{\partial {γ}_{i}}$ |
| 10: | $\frac{\partial x}{\partial {γ}_{i}} ← {f}_{u} \frac{1}{Z} \frac{\partial {X}_{c}}{\partial {γ}_{i}} - {f}_{u} \frac{{X}_{c}}{{Z}_{c}^{2}} \frac{\partial {Z}_{c}}{\partial {γ}_{i}}$ |
| 11: | $\frac{\partial {H}_{e} ( Φ ( x , y ) )}{\partial {γ}_{i}} ← δ ( Φ ) ( \frac{\partial Φ}{\partial x} \frac{\partial x}{\partial {γ}_{i}} + \frac{\partial Φ}{\partial y} \frac{\partial y}{\partial {γ}_{i}} )$ |
| 12: | $\frac{\partial E}{\partial {γ}_{i}} ← - {\sum }_{x ∈ Ω} \frac{{P}_{f} - {P}_{b}}{{H}_{e} ( Φ ) {P}_{f} + ( 1 - {H}_{e} ( Φ ) ) Pb} \frac{\partial {H}_{e} ( Φ ( x , y ) )}{\partial {γ}_{i}}$ |
| 13: | end for |
| 14: | ${E}_{i} ← {E}_{i} + \frac{\partial E}{\partial {γ}_{i}}$ |
| 15: | end for |

What is claimed is:

1. A method for estimating the shape and pose of a 3D object comprising:
detecting a 3D object external to a host using at least one image sensor;
using a processor, estimating at least one of the shape and pose of the detected 3D object relative to the host; and
providing an output of the estimated 3D object shape and pose.

2. The method of claim 1 further comprising:
obtaining a plurality of 3D object models, where the models are related to a type of object, but differ in shape and size;
using a processor, aligning and scaling the 3D object models;
voxelizing the aligned and scaled 3D object models;
creating a 2D height map of the voxelized 3D object models; and
training a principle component analysis model for each of the unique shapes of the plurality of 3D object models.

3. The method of claim 2 further comprising:
storing the principle component analysis model for 3D object models in a memory coupled to the processor.

4. The method of claim 2 further comprising:
for each successive image of the detected 3D object, iterating the estimation of the shape and pose of the detected 3D object until the model of the 3D object matches the shape and pose of the detected 3D object.

5. The method of claim 1 wherein the 3D object is a vehicle and the host is a vehicle.

6. The method of claim 5 wherein:
using the processor, estimating at least one of the shape and pose of the detected vehicle relative to the host vehicle while the detected vehicle and the host vehicle change position relative to each other.

7. An apparatus for estimating the shape and pose of a 3D object relative to a host comprising:
at least one sensor mounted in a host for sensing a 3D object in a vicinity of the host; and
a processor, coupled to the at least one sensor, the processor being operable to:
obtain a 3D object image from the at least one sensor;
estimating the shape of the object in the 3D object image;
estimating the pose of the 3D object in the 3D object image;
optimizing the estimated shape and pose of the 3D object until the estimated 3D object shape and pose substantially match the 3D object image; and
outputting the shape and pose of the optimized 3D object.

8. The apparatus of claim 7 further comprising:
a control mounted on the host for controlling at least one of the host function; and
the processor transmitting the output of the optimized shape and pose of the 3D object to the control.

9. The apparatus of claim 7 wherein:
the host is a vehicle and the at least one sensor is mounted on the host vehicle; and
the detected 3D object is a vehicle.

10. The apparatus of claim 9 wherein:
the processor optimizes the estimated shape and pose of the detected vehicle while at least one of the detected vehicle in the host vehicle are moving relative to each other.
